(19) United States
(12) Patent Application Publication
(10) Pub. No.: US 2015/0102106 A1
(43) Pub. Date: Apr. 16, 2015

(54) TAMPER-PROOFING AN INTEGRATED MAGNETIC STRIPE READER HEAD

(71) Applicant: Hyung Tae Choi, Anyang-Si (KR)

(72) Inventor: Hyung Tae Choi, Anyang-Si (KR)

(73) Assignees: MSRTEK INC., Irvine, CA (US); TJ Solutions, Anyang-Si (KR)

(21) Appl. No.: 13/969,541

(22) Filed: Aug. 17, 2013

(51) Int. Cl. G06K 7/08

(52) U.S. Cl. CPC G06K 7/084
USPC 235/449

(57) ABSTRACT

An integrated magnetic stripe reader (MSR) head apparatus for preventing the theft of data stored on a magnetic stripe of a magnetic stripe card in magnetic card reader system is provided. The apparatus comprises an MSR head and a flexible printed circuit board (FPCB). The FPCB integrates all necessary components on its front side, including an MSR integrated circuit (IC), circuit lines, and a cable connector for enabling communication between the MSR IC and an external host processor. The apparatus connects the MSR head and the FPCB using pin-terminal connectors or socket connectors tightly. An attempt to tap a signal on a signal path between the MSR head and the MSR IC disconnects the MSR head from the FPCB, causing the apparatus to break operation so that the signal path for tapping cannot be created in the first place.

### CROSS-REFERENCE TO RELATED APPLICATIONS

Pursuant to 35 U.S.C. 119(a) and 119(d), this application claims right of priority to Korean Patent Application No. 10-2013-004724 filed on Apr. 29, 2013. The content of said patent application is incorporated herein by reference in its entirety.

### TECHNICAL FIELD

The claimed subject matter relates generally to magnetic stripe card reader systems and, more particularly, to a tamper-proof integrated magnetic stripe reader (MSR) head for reading data stored in the magnetic stripe of a magnetic stripe card.

### BACKGROUND

A magnetic stripe card is a type of card capable of storing data by modifying one or more bars of magnetic material on the card. The magnetic material may collectively be referred to as a magnetic band, or magnetic stripe. The magnetic stripe is read by swiping the magnetic stripe past an MSR head.

Each signal induced, or read, by the MSR head is transferred to an MSR integrated circuit (IC), which decodes the signal. The decoded signal is typically encrypted by the MSR IC and securely transmitted to the host processor of a magnetic stripe card reader system.

Unfortunately, since the signal read by the MSR head is an unencrypted analog waveform, theft of the data stored in the magnetic stripe may occur while the magnetic stripe card is being swiped for a transaction if the signal is tapped while being transmitted between the MSR head and the MSR IC.

In general, an integrated MSR head integrates the MSR head and the MSR IC, such that all components, including the printed circuit board (PCB) where the MSR IC resides, are potted inside the MSR head cap. After assembly of all of the components including the PCB, the remaining space on the backside of the PCB inside the MSR head cap is hermetically sealed with an inert material such as epoxy resin or silicon to protect the components inside.

However, a wired connection between the MSR head and the MSR IC is usually made by soldering them together. Additionally, the inert material that protects the components inside the MSR head may be disintegrated, exposing circuit lines on the PCB. The soldered area of the connector from the MSR head and the exposed circuit lines between the MSR head and the MSR IC can be accessed without breaking operation of the integrated MSR head. This exposed signal path may allow theft of the data stored on the magnetic stripe through signal tapping.

An improved integrated MSR head is needed to address the above-noted shortcomings.

### SUMMARY

The present disclosure is directed to constructing a tamper-proof integrated MSR head apparatus.

For purposes of summarizing, certain aspects, advantages, and novel features have been described herein. It is to be understood that not all such advantages may be achieved in accordance with any one particular embodiment. Thus, the claimed subject matter may be embodied or carried out in a manner that achieves or optimizes one advantage or group of advantages without achieving all advantages as may be taught or suggested herein.

In accordance with one embodiment, a tamper-proof integrated MSR head apparatus is provided for a magnetic stripe card reader system. The apparatus prevents theft of data stored in the magnetic stripe of a magnetic stripe card by tapping a signal transmitted between an MSR head and an MSR IC included in the MSR head apparatus.

The tamper-proof integrated MSR head apparatus comprises a MSR head unit and a flexible printed circuit board (FPCB) unit. The MSR head unit comprises a magnetic core and a head cap and performs electromagnetic induction as a magnetic stripe card is swiped along the MSR head unit. The FPCB unit integrates all necessary components, including the MSR IC, circuit lines connecting one or more of the components, and a cable connector connecting the MSR IC and the host processor of the magnetic stripe card reader system.

The host processor controls the magnetic stripe card reader system and usually resides outside the integrated MSR head apparatus. The MSR IC resides on the FPCB and performs decoding for the analog signals read by the MSR head and transmits the decoded signals to the host processor through a cable connector. The decoded signals from the MSR IC are usually encrypted and securely transmitted to the host processor to prevent data from being stolen.

In the tamper-proof integrated MSR head apparatus, the MSR head unit and the FPCB unit are tightly connected by either pin-terminal connectors or socket connectors. The FPCB unit is designed such that all necessary components, including the circuit lines, reside on one side of the FPCB unit.

In one embodiment, all FPCB components and circuit lines reside on the front side of the FPCB unit. In order to steal data stored in the magnetic stripe, a hacker must tap a signal on a signal path between the MSR head and the MSR IC. However, to gain access to the front side of the FPCB unit where all the components reside, the protective inert material needs to be removed first and the entire FPCB unit must be lifted up, which results in disconnection between the MSR head and the MSR IC. The disconnection between the MSR head and the MSR IC prevents the signal path between the MSR head and the MSR IC from being created, thereby preventing the signal tapping.

In other words, the tamper-proof integrated MSR head apparatus of the present invention prevents theft of the data stored in the magnetic stripe by making signal tapping infeasible from the beginning. Signal tapping cannot be performed because the signal path between the MSR head and the MSR IC is never created in the first place due to the disconnection between the MSR head and the MSR IC.

One or more of the above-disclosed embodiments in addition to certain alternatives are provided in further detail below with reference to the attached figures. The claimed subject matter is not, however, limited to any particular embodiment disclosed.

### BRIEF DESCRIPTION OF THE DRAWINGS

Embodiments of the claimed subject matter are understood by referring to the figures in the attached drawings, as provided below.

FIG. 1 illustrates a conventional integrated MSR head.

FIG. 2 illustrates a detached PCB from the conventional integrated MSR head shown in FIG. 1.

FIG. 3 illustrates a cross section view of the conventional integrated MSR head shown in FIG. 1.

FIG. 4 illustrates a detached FPCB from a tamper-proof integrated MSR head, where the MSR head unit and the FPCB unit are connected by pin-terminal connectors, in accordance with one embodiment.

FIG. 5 illustrates a cross section view of the tamper-proof integrated MSR head, where the MSR head unit and the FPCB unit are connected by pin-terminal connectors as shown in FIG. 4.

FIG. 6 illustrates a detached FPCB from a tamper-proof integrated MSR head where the MSR head unit and the FPCB unit are connected by socket connectors, in accordance with one embodiment.

FIG. 7 illustrates a cross section view of the tamper-proof integrated MSR head, where the MSR head unit and the FPCB unit are connected by socket connectors as shown in FIG. 6.

Features, elements, and aspects that are referenced by the same numerals in different figures represent the same, equivalent, or similar features, elements, or aspects, in accordance with one or more embodiments.

### DETAILED DESCRIPTION OF EXEMPLARY EMBODIMENTS

In the following, numerous specific details are set forth to provide a thorough description of various embodiments of the claimed subject matter. Certain embodiments may be practiced without these specific details or with some variations in detail. In some instances, certain features are described in less detail so as not to obscure other aspects of the disclosed embodiments. The level of detail associated with each of the elements or features should not be construed to qualify the novelty or importance of one feature over the others.

A magnetic stripe reader system may comprise an integrated MSR head for reading data stored in the magnetic stripe of a magnetic stripe card. The integrated MSR head may be a single module, or body integrating an MSR head and a PCB on which an MSR IC resides.

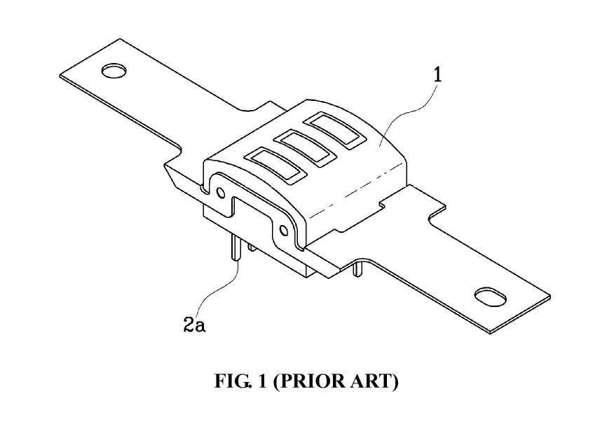

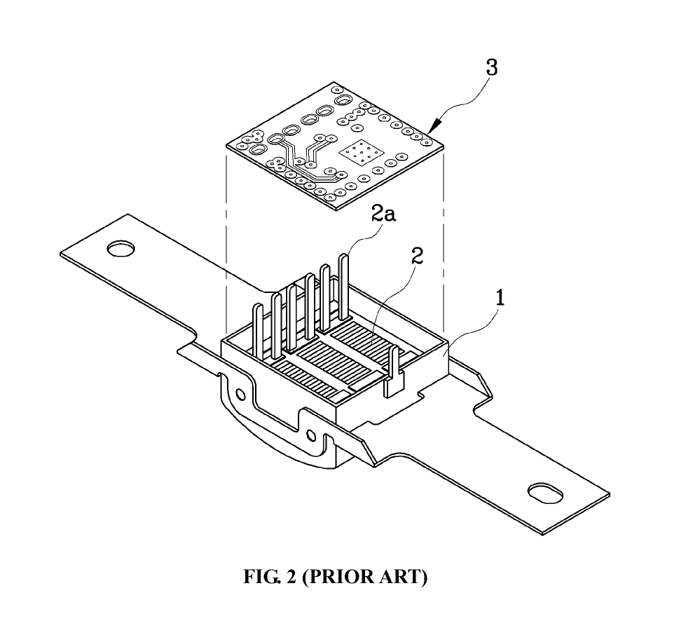

Referring to FIGS. 1, 2, and 3, a conventional integrated MSR head comprises an MSR head unit (1), a PCB (3), and a cable connector (6). The output port (2a) of the MSR head unit (1) is wire connected to the input port of the MSR IC (4) on the PCB (3). The MSR IC (4) recovers data stored in a magnetic stripe of a magnetic stripe card by decoding induced analog signals on the MSR head unit (1) as the magnetic stripe card is being swiped past the MSR head unit (1). The data recovered by the MSR IC (4) is usually encrypted and securely transmitted to the host processor of a magnetic stripe card reader system via the cable connector (6).

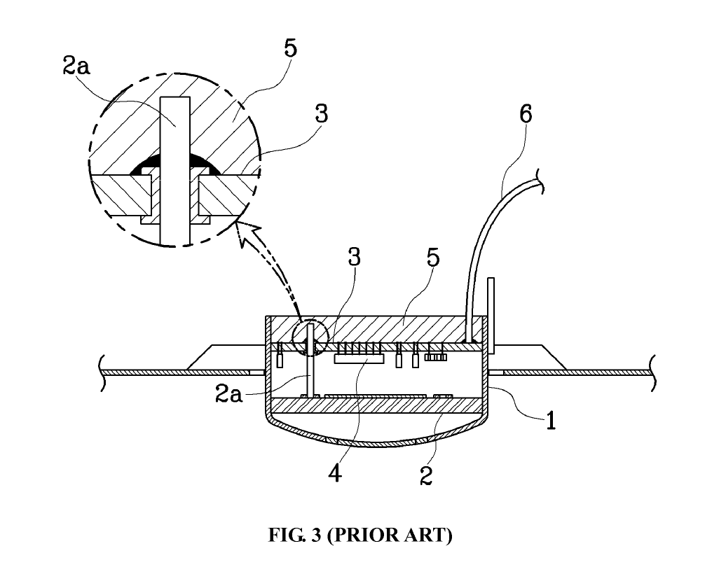

Referring to FIG. 3, the backside of PCB (3) is hermetically sealed with an inert material (5) such as epoxy resin or silicon. However, the inert material may be disintegrated without breaking the cable connector (6) or the PCB (3). In such a case, signal tapping to steal the stored data in the magnetic stripe is feasible at the output port (2a) or on a circuit line on the PCB (3).

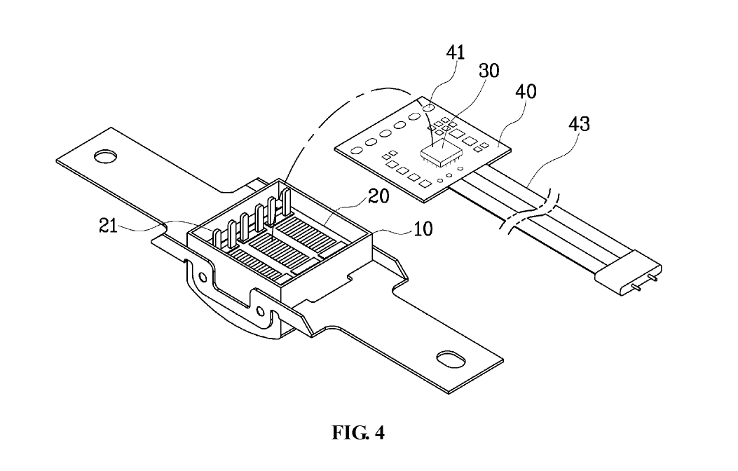

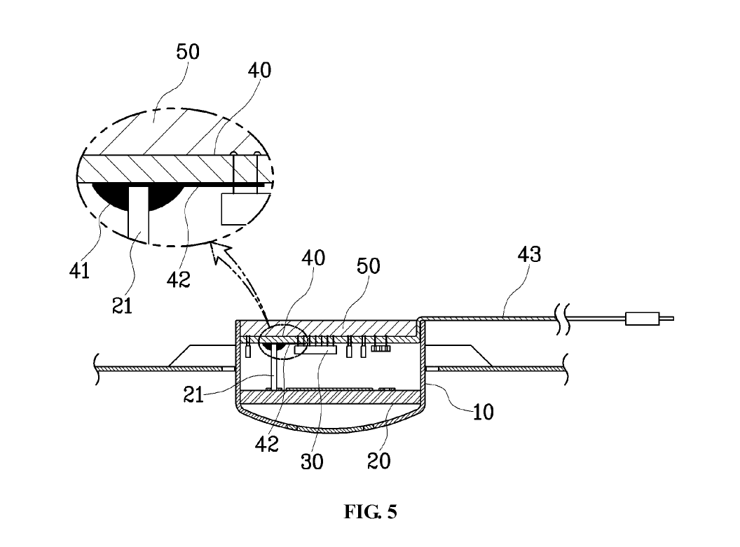

In FIGS. 4 and 5, a schematic diagram of a tamper-proof integrated MSR head is drawn in accordance with one embodiment of the present invention. The tamper-proof integrated MSR head comprises an MSR head unit (10), a single body FPCB (40), and connector terminals (21) connecting the MSR head unit (10) and the FPCB unit (40). The cable connector (43), which connects the MSR IC (30) output port to the outside host processor, is seamlessly integrated into the FPCB unit (40), forming a single body FPCB (40).

Referring to FIG. 5, in one embodiment, on the front side surface of the FPCB (40), the connector terminals (41) are formed toward the MSR head unit (10) in order to incorporate pin connection from the MSR head unit (10). The connector terminals (41) are connected to the MSR IC (30) input pins by the circuit lines (42) on the front side of the FPCB (40). The connector terminals (41) include a bias voltage connection which is supplied to the MSR head unit (10).

The tamper-proof integrated MSR head according to the present invention integrates two units: the MSR head unit (10) and the single body FPCB (40). In one embodiment, the MSR head unit (10) and the single body FPCB unit (40) are connected by connector pins (21).

Still referring to FIG. 5, in one embodiment, a cable connector (43) is pulled out of the MSR head unit (10), the MSR head unit (10) and the FPCB (40) unit are assembled, and, finally, the front side of the FPCB (40) is doped and sealed by spraying an inert material (50) such as epoxy resin or silicon.

When a magnetic stripe card is swiped past the MSR head (20), the induced signal on the MSR head (20) is transmitted to the MSR IC (30) through the pin connectors (21) and the circuit lines (42) on the FPCB (40). The pin connectors (21) also supply a bias voltage to the MSR head (20). The MSR IC (30) amplifies the induced signal, performs decoding and recovering of the data stored in the magnetic stripe, encrypts the recovered data in digital form, and transmits the encrypted data to the outside host processor via the FPCB cable connector (43).

Even if the inert material (50) is disintegrated, no circuits are exposed on the back side of FPCB (40). In an attempt to tap the signal on the circuit lines (42) or at the connector terminals (41) on the front side of FPCB (40), the FPCB cable connector (43) must be lifted up to gain access the space below the FPCB (40). In such a case, the pin connectors (21) are removed from the connector terminals (41), and the MSR head (20) is disconnected from the FPCB (40), which results in no signal transmission from the MSR head (20) since no bias voltage is supplied to the MSR head (20).

Referring to FIG. 5, in one embodiment, the pin connectors (21) are soldered down to the connector terminals (41) on the FPCB (40).

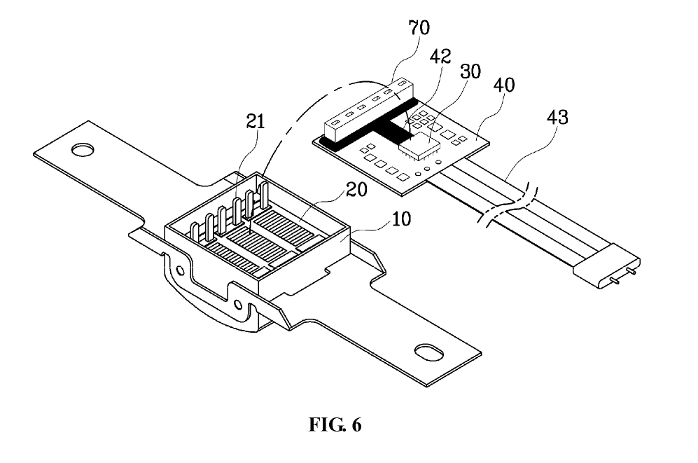

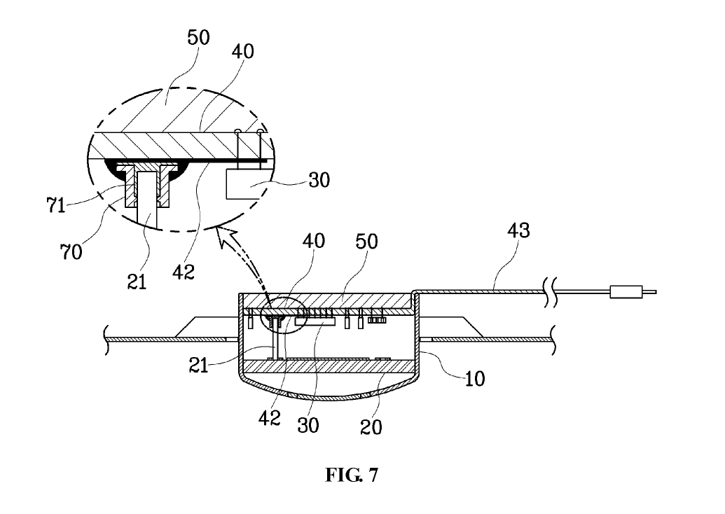

Referring to FIGS. 6 and 7, in another embodiment, the connection between the MSR head (20) and the MSR IC (30) is a socket connector (70).

Referring to FIG. 6, in one implementation, a female socket connector (70) is attached to the front side of the FPCB (40), and a male socket connector (21) is attached to the MSR head (20). To make the connection hold tight, the size of the female socket connector opening is constructed to be smaller than that of the male socket connector counterpart. The circuit lines (42) from the female connector socket (70) to the MSR IC (30) are formed on the front side of FPCB (40) to create a signal path between the MSR head (20) and the MSR IC (30). It should be noted that the female socket connector (70) shown in FIG. 6 is a single connector having a plural of connector ports; however, depending on implementation, there may be a separate connector for each signal port.

Referring to FIG. 6, in one implementation, the cable connector (43) connecting the MSR IC (30) output to the outside host processor is seamlessly integrated into the FPCB (40).

Referring to FIG. 7, in one implementation, after the male pin connector (21) is inserted into the female socket connector (70), the left over space in the MSR head cap (10) is sealed by doping or spraying inert materials (50) such as epoxy resin on the back side of the FPCB surface.

Referring to FIG. 7, in one implementation, when a magnetic stripe card is swiped through the MSR head (20), the induced signal on the MSR head (20) is transmitted to the MSR IC (30) through the socket connector (21) and the circuit lines (42) on the FPCB (40).

Referring to FIG. 7, even if the inert material (50) is disintegrated, no circuits, connectors, or connection terminals are exposed on the backside of the FPCB (40). A hacker must lift up the FPCB to tap the signal from the MSR head (20) on the front side of FPCB (40). However, if the FPCB (40) is lifted up to gain access inside of the MSR head cap (10), the male pin connector (21) is removed from the female socket connector (70), which results in no communications between the MSR head (20) and the MSR IC (30) including the bias voltage supplied to the MSR head.

The claimed subject matter provides an integrated MSR head apparatus for performing secure, or tamper-proof, magnetic stripe card reading. The tamper-proof integrated MSR head is obtained by constructing a single body FPCB, including connecting an MSR head and an MSR IC using a pin-terminal connector or a socket connector and connecting the MSR IC and an outside host processor IC using a cable connector.

Therefore, the tamper-proof integrated MSR head apparatus of the present invention prevents theft of data stored in a magnetic stripe of a magnetic stripe card by making signal tapping infeasible. Signal tapping cannot be performed because a signal cannot be transmitted between an MSR head and an MSR IC of the integrated MSR head apparatus when the MSR head and the MSR IC are disconnected.

The claimed subject matter has been described above with reference to one or more features or embodiments. Those skilled in the art will recognize, however, that changes and modifications may be made to these embodiments without departing from the scope of the claimed subject matter. These and various other adaptations and combinations of the embodiments disclosed are within the scope of the claimed subject matter as defined by the claims and their full scope of equivalents.

What is claimed is:

1. A tamper-proof integrated magnetic stripe reader (MSR) head apparatus, the apparatus comprising:
a magnetic head unit for reading a signal from a magnetic stripe as the magnetic stripe is swiped past the magnetic head unit, wherein said magnetic head unit comprises a magnetic core and a head cap;
a flexible printed circuit board (FPCB) unit for decoding the signal and transmitting the decoded signal to an external host processor.

2. The apparatus of claim 1, wherein said FPCB unit is a single body unit that integrates a plurality of components on a single side surface, the plurality of components comprising: an MSR integrated circuit (IC), a cable connector connecting said MSR IC to said host processor, and one or more circuit lines for electrically connecting one or more of the plurality of components of said FPCB unit.

3. The apparatus of claim 2, wherein said plurality of components integrated on said single side surface of said FPCB unit further comprises a plurality of connector terminals, and wherein said magnetic head unit comprises a plurality of corresponding connector pins.

4. The apparatus of claim 3, wherein said magnetic head unit and said FPCB unit are connected by inserting said connector pins into said connector terminals.

5. The apparatus of claim 1, wherein said FPCB unit comprises a female socket connector, and wherein said magnetic head unit comprises a male socket connector.

6. The apparatus of claim 5, wherein said magnetic head unit and said FPCB unit are connected by inserting said male socket connector into said female socket connector.

7. The apparatus of claim 1, wherein the apparatus is constructed by doping or spraying inert materials on the back side surface of said FPCB unit after said magnetic head unit and said FPCB unit are assembled.
